(19) United States
(12) Patent Application Publication
(10) Pub. No.: US 2021/0022356 A1
(43) Pub. Date: Jan. 28, 2021

(54) Process for Aseptically Preparing Fruits and Vegetables

(71) Applicant: David Don Albrecht, LeMars, IA (US)

(72) Inventor: David Don Albrecht, LeMars, IA (US)

(21) Appl. No.: 16/936,662

(22) Filed: Jul. 23, 2020

Related U.S. Application Data
(60) Provisional application No. 62/877,616, filed on Jul. 23, 2019.

(51) Int. Cl. A23B 7/005; A23B 7/04; A23L 3/16; A23L 3/36; A23L 19/12; A23L 5/10

(52) U.S. Cl. CPC A23B 7/005; A23B 7/04; A23L 3/165; A23V 2002/00; A23L 19/13; A23L 5/13; A23L 3/36

(57) ABSTRACT

Provided are processes for aseptically preparing fruits and vegetables, such as mashed potatoes wherein the process minimizes and/or eliminates free starch in the final product, thereby resulting in a product having a superior taste and/or texture. The process includes heating of the fruit or vegetable to a temperature sufficient to gelatinize starch in the fruit or vegetable. Moreover, the fruit or vegetable may then be cooled, such as to set the structure of the fruit's or vegetable's starch cells. The fruit or vegetable may be reduced in size, such as to about ¼ inch before mixing with further ingredients. The fruit or vegetable is then sterilized, which may include a 5 log kill step and result in halting the enzymatic reactions within the fruit or vegetable. After sterilization, the potatoes may then be cooled before being aseptically packaged and stored.

### FIELD OF THE INVENTION

The present invention relates to aseptic, packaged foods. More specifically, the present invention relates to a process for aseptically preparing mashed potatoes, as well as other vegetables and fruits.

### BACKGROUND

Over the years, a wide variety of techniques have been developed for storing and producing food products. Well known techniques include freezing, canning, irradiation and drying of foods. Foods are also often prepared using aseptic packaging methods. Aseptic packaging includes processing the food product by heating it to a sufficient temperature to destroy pathogenic organisms. The product is then placed in packaging which has also been made aseptic. After the packaging is sealed, it may provide a barrier against one or more of the following: oxygen, light, moisture, temperature changes, and/or penetration by harmful organisms or pathogens. Aseptic packaging methods may allow food products to be stored at room temperature for extended periods of time without spoiling or degradation of the food product.

Aseptic packaging techniques have been successfully used to package fruits, vegetables, and meats. For example, United States Patent Publication No. 2004/0191382 to Cooper is directed to an ultra-high pressure sterilization method and resulting product. The process includes producing at least a partially cooked mashed vegetable, such as potatoes or beans, which is packaged and sterilized and has a flavor that is substantially unchanged after high-pressure sterilization. The vegetables are partially cooked, such as to at least 90 degrees Celsius to achieve at minimum about 90% gelatinization of the potato starch. A ricer with grid openings of 0.374 inches is used to create a continuous, consistent mass of potato. The temperature of the potatoes is kept above 30 degrees Celsius. The potatoes are then packaged and subsequently sterilized via known methods.

In another method, U.S. Pat. No. 6,177,115 to Meyer discloses an ultra-high pressure, high temperature food preservation process. The disclosed method makes use of ultra-high pressure to destroy spoilage-causing microorganisms and spoilage-related endogenous enzymes. The preferred embodiment of the invention includes preheating a food to an initial temperature, preferably above 158 degrees Fahrenheit, more preferably to at least 185 degrees Fahrenheit and most preferably to a temperature between 194 degrees Fahrenheit and 212 degrees Fahrenheit. The preferred embodiment additionally includes two or more cycles of ultra-high pressure, high initial temperature and instantaneous, uniform adiabatic heating and adiabatic temperature reduction. The method calls for a pause between each cycle wherein pressure is released, and the mass is cooled to achieve sterilization and eliminate spores surviving initial pressurization without adversely impacting flavor or texture.

In yet another reference, United States Patent Application Publication No. 2005/0255229 to Liukko, a process is disclosed for preparing an edible product comprising starch-containing material. The process includes the mechanical mashing of raw potatoes or maturing of the same. Water and flavorings may be added to the mash before heating under pressure to a temperature above 212 degrees Fahrenheit.

Lastly, U.S. Pat. No. 7,081,266 to Martines et al. discloses dehydrated potato flakes prepared from potato slices, slivers, and/or nubbins. The potato flakes are suitable for use in dough composition that is used to make fabricated products. Specifically, the method includes cooking raw potato pieces under atmospheric pressure with steam for a time sufficient to swell the potato cells and separate the potato cells from each other without breaking more than 60% of the starch cells. Preferably, during the cooking process the temperature of the potato pieces rises from about 65 degrees Fahrenheit to about 212 degrees Fahrenheit during the first one-third of the cycle and then is maintained for the remainder of the cooking cycle. The temperature of the potatoes is preferably maintained in order to minimize cooling until the cooking process is complete.

The above-described methods have drawbacks. Namely, these methods do not avoid breaking starch cells, which results in a final product having a gluey texture and taste. Accordingly, there is still a need in the art for an improved method of aseptically preparing and packaging a food product, such as mashed potatoes, which achieves proper sterilization without undercooking or overcooking the food and without impairing the food texture or taste. The current method addresses these drawbacks to result in a process wherein free starch is avoided in the final product and starch is properly gelatinized so as to avoid breakage of the starch cell, which results in a final product having a desired taste and texture. Moreover, the current invention may employ sterilization that destroys pathogens and uses heat to halt enzymatic reactions in the final product which increases the shelf life of the product.

### SUMMARY OF THE INVENTION

Provided are processes for aseptically preparing fruits and vegetables having starch, such as a potato. In one embodiment, the processes may comprise heating fruits and vegetables to a first temperature sufficient to gelatinize starch in the fruits and vegetables. Following heating, the fruits and vegetables are cooled to a second temperature sufficient to set starch cell structure. A first temperature sufficient to gelatinize starch in the fruits and vegetables may be between 120 degrees Fahrenheit and 212 degrees Fahrenheit, such as between 150 degrees and 212 degrees Fahrenheit, or most preferably between 130 degrees and 170 degrees Fahrenheit. A second temperature sufficient to set the starch cell structure of the fruits and vegetables may be between 55 degrees and 100 degrees Fahrenheit. Further, cooling of the fruits and vegetables may reduce free starch in the prepared product. After cooling, the fruits and vegetables may be reduced to at least one smaller particle size and then may be sterilized. Sterilization may include a 5 log kill step and may halt enzymatic reactions in the product, resulting in a longer shelf-life.

In another embodiment, a process for aseptically preparing mashed potatoes from at least one potato having starch is provided. In one embodiment, the process may comprise heating a potato to a first temperature between 120 degrees and 212 degrees Fahrenheit to gelatinize starch in the potato. Before heating, the potatoes may be reduced to particles having a first size. Following heating, the potatoes are cooled to a second temperature between 55 degrees and 100 degrees Fahrenheit to set the structure of starch cells such that they are less likely to break prior to consumption. After being cooled, the particles of potatoes again may be reduced to particles having a second size of one quarter of an inch. Next, the potatoes are sterilized. Sterilization may include a 5 log kill step and may halt enzymatic reactions in the product, resulting in a longer shelf-life.

In yet another embodiment, a process is provided for aseptically producing mashed potatoes from at least one potato having starch and at least one starch cell wall. In one embodiment, the process may comprise dicing a potato. Next, the diced potato is heated to a first temperature between 120 degrees to 212 degrees Fahrenheit such that the starch in the potato is gelatinized. After heating, the potato is cooled such that rigidity is increased in at least one starch cell wall. Next, the cooled potato is reduced in particle size to about one quarter of an inch. After being reduced in size, the potato is sterilized. Sterilization may include a 5 log kill step and may use heat to halt enzymatic reactions in the potato.

### BRIEF DESCRIPTION OF THE DRAWINGS

FIG. 1 is a flow chart of the steps of a first embodiment of a process for aseptically preparing mashed potatoes of the present invention.

FIG. 2 is a flow chart illustrating the steps of a second embodiment of a process for aseptically preparing mashed potatoes of the present invention.

### DETAILED DESCRIPTION

Disclosed is a process for aseptically preparing mashed fruits and vegetables. For ease of discussion and understanding, the following detailed description and illustrations often refer to the process for use with potatoes. It should be appreciated that the method of the present invention may be used with any fruits and vegetables. This process has numerous benefits. It allows the final product to be transported and stored for prolonged periods of time and creates a relatively temperature insensitive product. Therefore, the product can be stored at a temperature ranging from the freezing point of the product to a temperature of 100 degrees Fahrenheit or higher without noticeable changes to the product's quality. Another advantage of the process is that free starch is reduced and/or eliminated which causes the final product to have a superior taste and/or texture compared to aseptically produced mashed fruits and vegetables of the prior art. Moreover, by preferably reducing the particle size of the fruits and vegetables prior to the sterilization step, the fruits or vegetables are uniformly and completely heated during the sterilization step, creating a safer and better tasting product.

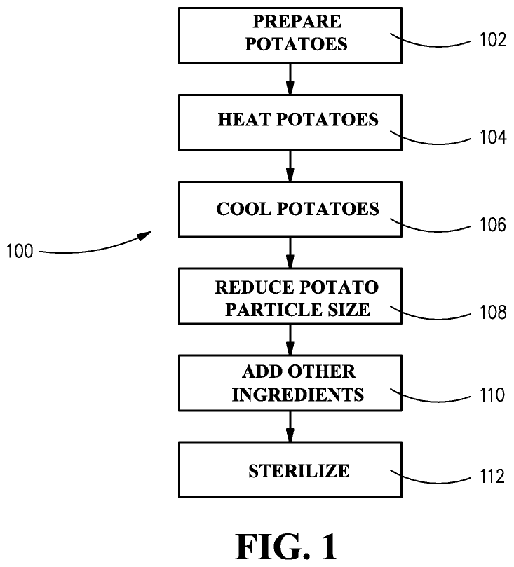

Referring now to FIG. 1, a first embodiment of the process 100 as it relates to potatoes consists of the following steps, each of which will be described in detail herein below. First, the potatoes are prepared 102 for the disclosed method. Next, the potatoes are heated 104, for example by cooking the potatoes. The potatoes are then cooled 106 before reducing the particle size of the potatoes 108. Optionally, the potatoes may be mixed with other ingredients 110, such as flavoring ingredients. Lastly, the potatoes are sterilized 112.

To prepare the potatoes 102 for the process of the present invention, the potatoes may be washed, peeled, sorted, and/or diced in some embodiments. The potatoes may be washed using an acid wash or any wash or wash sequence known in the art, now or in the future. After the wash, the potatoes may be immediately sorted or preferably peeled. As will be understood by one of skill in the art, certain products may preferably include peels. If desired, some methods of peeling include steaming the potatoes or using caustic. Any method of peeling known in the art, now or in the future, may be used. The potatoes may then be sorted to eliminate potatoes which include defects or abnormalities. Any method of sorting may be used, whether known now or in the future. The potatoes may then be reduced to a pre-processing size to promote uniform heating or cooking in later steps. The potatoes may be reduced in size by dicing or by any method known in the art now or in the future. Finally, the potatoes may be prepared for the process of FIG. 1 by being examined and sorted to remove internal defects or abnormalities using any method of sorting known now or in the future.

After the optional preparation step(s), the potatoes are heated 104. In the preferred embodiment, the potatoes are cooked all the way through so that they may be mashed later in the process. Fruits and vegetables, such as potatoes, include starch grains that consist of molecules of starch and pectins chemically linked together with covalent bonds. When the starch grains are heated, they swell and separate. Swelling of the starch grains is called gelatinization, which allows the potatoes to be mashed to the proper consistency. Specifically, the product may be heated using a process that may employ boiling water or retrogradation. When this process is used to heat fruits and/or potatoes, separation of the starch grains is reduced and a firm gel is formed. Therefore, the cooked product may be prevented from crumbling, disintegrating, or developing an undesirable taste and/or texture.

The potatoes may be heated 104 using a heating device such as a water bath that utilizes steam or boiling water, as discussed above. To cook the potatoes all the way through, the potatoes may be heated to a temperature between 120 degrees Fahrenheit and 212 degrees Fahrenheit, such as to 150 to 212 degrees Fahrenheit, or most preferably 130 to 170 degrees Fahrenheit. For example, the potatoes may be cooked to 120 degrees Fahrenheit, 125 degrees Fahrenheit, 130 degrees Fahrenheit, 135 degrees Fahrenheit, 140 degrees Fahrenheit, 145 degrees Fahrenheit, 150 degrees Fahrenheit, 155 degrees Fahrenheit, 160 degrees Fahrenheit, 165 degrees Fahrenheit, 170 degrees Fahrenheit, 175 degrees Fahrenheit, 180 degrees Fahrenheit, 185 degrees Fahrenheit, 190 degrees Fahrenheit, 195 degrees Fahrenheit, 200 degrees, 205 degrees Fahrenheit, 210 degrees Fahrenheit, and/or 212 degrees Fahrenheit. Preferably, the potatoes are heated to a temperature of about 160 degrees Fahrenheit. Accordingly, the fruits or vegetables, such as potatoes, are heated to a temperature wherein the starch is gelatinized.

Referring again to FIG. 1, after being heated 104 the product is cooled 106. As discussed above, fruits and vegetables, such as potatoes, may be heated or cooked using a process called retrogradation. As the heated or cooked starch grains cool, the molecules of starch and pectin may begin to realign. The realignment of the molecules during the cooling step is important to properly gelatinize the starch in the potatoes, or other fruits or vegetables. Additionally, this step may allow free starch in the product to be washed away and therefore reduce free starch in the final product. While this step may be optional in some embodiments, cooling sets the gelatinized starch cell structure such that the cells are firmer and do not break. Breakage of the cells results in free starch in the final product, which leads to an undesirable taste and/or texture, such as a gluey taste and/or texture. Accordingly, in some embodiments, it is important to keep the starch cells intact and reduce free starch in the final product.

In the embodiment of FIG. 1, the potatoes may be cooled to a temperature between 55 degrees Fahrenheit and 100 degrees Fahrenheit. The potatoes may be cooled to 55 degrees Fahrenheit, 60 degrees Fahrenheit, 65 degrees Fahrenheit, 70 degrees Fahrenheit, 75 degrees Fahrenheit, 80 degrees Fahrenheit, 85 degrees Fahrenheit, 90 degrees Fahrenheit, 95 degrees Fahrenheit. In preferred embodiments, the potatoes may be cooled to room/ambient temperature or below. The potatoes may be cooled using liquid nitrogen, cold air, gaseous carbon dioxide, or other cooling devices known now or in the future. Preferably, a cooling water bath or shower may be used to cool the potatoes and to remove excess free starch from the product. In some embodiments, the potatoes may be blanched, which involves both heating and cooling of the potatoes. Accordingly, in this step the fruits or vegetables may be cooled to a temperature wherein the starch cell structure, such as the cell wall, is set so as to avoid breakage.

After the potatoes are cooled 106, the particle size of the pre-processing sized fruit and/or vegetable pieces is further reduced 108. In the embodiment of FIG. 1 employing potatoes, the size of the potatoes may be reduced to ¼ inch or less. In some embodiments, the potatoes may go through a die, press, ricer, or other mechanical shredding device to reduce their size. As discussed above, it is important in this step to maintain the integrity of the starch cell structure, for example the starch cell wall, and to avoid breaking the cell structure, such as the cell wall. Breakage will result in undesirable free starch in the product. One way to ensure that the cell structure does not break is to use a die, press, or ricer around ¼ inch. To aid in this step, in some embodiments a lubricant such as butter or another similar material may be added prior to or during the reduction in size 108. Moreover, this sequence may include a sieve, ricer, die, and/or press where the holes are round with radiated corners. Accordingly, there are no sharp edges or corners to break the cell structure. Preferably, the resulting reduced-size pieces will accumulate in a holding tank for further reprocessing.

At this point, further ingredients may be added to the potatoes 110, or other fruits and/or vegetables. For example, salt, pepper, cream, garlic, cheese, vitamins, butter, and/or other flavorings may be added to the potatoes. This step may occur in the holding tank discussed above. The potatoes, with or without other ingredients, may be mixed in the holding tank.

After further ingredients have been added, the potatoes are sterilized 112. Sterilization may occur by any method known in the art, now or in the future. The sterilizer may utilize heat, high pressure, irradiation, microwave, chemical treatment, direct or indirect thermal resistance, radio frequency, ohmic, or any other system which will adequately sterilize the potato product. In some embodiments, the potatoes may be sterilized by heating the potatoes to a particular temperature and holding the potatoes at or above that temperature for a period of time which is sufficient to kill pathogens and halt enzymatic reactions in the product. It should be appreciated that the desired temperature may vary according to the desired results. Preferably, heating may occur via ohmic methods or a surface heat exchanger, although other methods and/or equipment may be used. For example, a scrape surface heat exchanger, commercially available from APV Crepaco, Inc., may be used. The scrape surface heat exchanger includes a cylindrical space containing a continuously rotating blade/auger which scrapes along the walls of the space to remove product from the walls. The walls of the exchanger are externally heated.

In the present invention, the potatoes may be heated to a temperature between about 250 degrees Fahrenheit and 312 degrees Fahrenheit, such as from 250 degrees Fahrenheit to 275 degrees Fahrenheit. The sterilization temperature may be 250 degrees Fahrenheit, 255 degrees Fahrenheit, 260 degrees Fahrenheit, 265 degrees Fahrenheit, 270 degrees Fahrenheit, 275 degrees Fahrenheit, 280 degrees Fahrenheit, 285 degrees Fahrenheit, 290 degrees Fahrenheit 295 degrees Fahrenheit, 300 degrees Fahrenheit, 305 degrees Fahrenheit, 310 degrees Fahrenheit, and/or 312 degrees Fahrenheit. In some embodiments, the sterilization temperature may be 250 degrees Fahrenheit when the potato particle size is ¼ inch or smaller. However, in some embodiments, the particle size could be larger, such as when a final product having larger chunks of potato is desired. In such case, different sterilization methods and/or parameters may be used. Moreover, different parameters may be used with different fruits and/or vegetables. While the time and temperature of the sterilization may change, in some embodiments it may be important to achieve a 5 log kill step and/or to allow the sterilization's heat to halt enzymatic reactions to prolong the shelf life of the resulting product. One advantage of sterilizing the product prior to packaging is that it allows for shorter sterilization time, resulting in a superior product.

After sterilization 112, the potatoes may be cooled. The product may be cooled in a cooling device where the heating process is stopped. One cooling device which may be used is a scrape surface heat exchanger, commercially available from APV Crepaco, Inc. The scrape surface heat exchanger is similar to the device described above except that the walls of the device are externally cooled.

After the product has cooled, the product is aseptically packaged using methods known in the art, now or in the future. The preferred method of packaging may include an aseptic packager. The aseptic packager operates by using steam or hydrogen peroxide in combination with steam to clean and sterilize a spout at a temperature sufficient to kill pathogens. Next, the aseptic packager may inject the sterilized mashed potato product into bags through the sterilized spout. The mashed potato product could be prepared for any ultimate use, including but not limited to commercial, industrial, individual and/or retail use, in any type of container known now or in the future such as large bulk bags, single serving bags, or cups for single family use. The containers may be comprised of packaging material that may include high barrier material or foil barrier bags that could form a barrier against oxygen, light, pathogens, moisture, and/or temperature changes. The containers and/or packaging material may be made aseptic through irradiation or any other known sterilization method.

Finally, the aseptically packaged product of the present invention can be shipped to a final destination for purchase or use. In some embodiments, the product may have a shelf-life of one year or more without degrading. The packages of mashed potatoes may be stored at a range of temperatures, such as between 32 degrees Fahrenheit and 120 degrees Fahrenheit, or more preferably 40-100 degrees Fahrenheit without changes in food quality. The storage temperature may be 32 degrees Fahrenheit, 35 degrees Fahrenheit, 40 degrees Fahrenheit, 45 degrees Fahrenheit, 50 degrees Fahrenheit, 55 degrees Fahrenheit, 60 degrees Fahrenheit, 65 degrees Fahrenheit, 70 degrees Fahrenheit, 75 degrees Fahrenheit, 80 degrees Fahrenheit, 85 degrees Fahrenheit, 90 degrees Fahrenheit, 95 degrees Fahrenheit, 100 degrees Fahrenheit, 105 degrees Fahrenheit, 110 degrees Fahrenheit, 115 degrees Fahrenheit, and/or 120 degrees Fahrenheit. In some embodiments, the packages of mashed potatoes may be stored at room temperature, however, storage temperatures of about 60 degrees Fahrenheit to 70 degrees Fahrenheit are preferred. With the methods of the present invention, the product requires no preservatives to maintain the described shelf life.

After the product is shipped, the packaged aseptic vegetables and/or fruits can be warmed in a static warmer hours before use. This will allow convenient use of the mashed potatoes at the correct temperature without added labor or waste of premade mashed potatoes.

The above steps may take place as a continuous process. In such a case, a pump may be used to move the potatoes through the various steps. In one example, the pump may be used to move the potatoes from the holding tank wherein the potatoes are mixed with flavoring through the sterilization process. Pumps which are useful in the present invention include, but are not limited to, positive displacement pumps such as lobe pumps and piston pumps. As the pump presents another opportunity for the cell structure to be damaged if proper methods are not used to ensure the integrity of the cells, care must be taken when using a pump. As discussed above, if the cells are damaged, free starch will be released which results in a low-quality product.

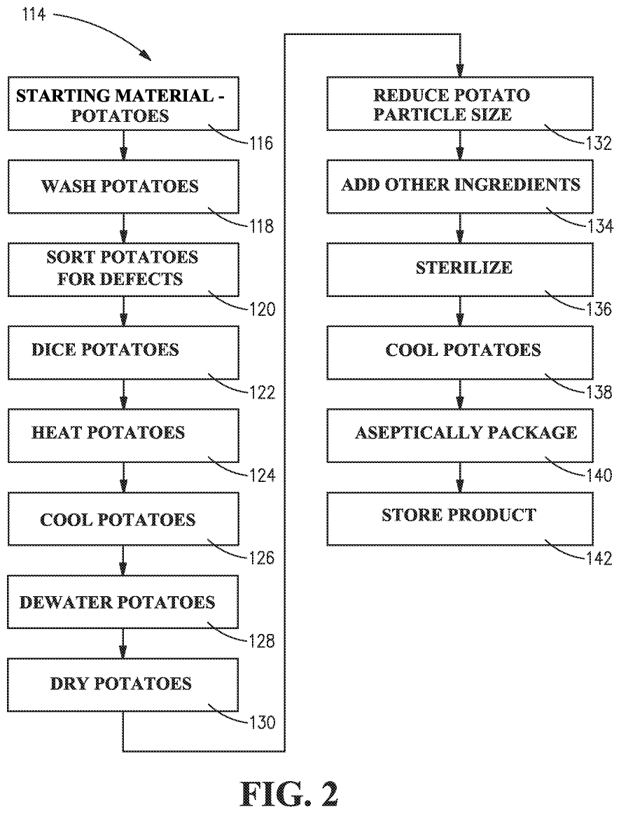

Referring now to FIG. 2, a second embodiment of the process 114 consists of the following steps, each of which will be described in detail herein below. First, the starting material is selected; in the illustrated embodiment the starting material is potatoes 116. Next, the potatoes are washed 118, followed by the potatoes being sorted for defects 120. After being sorted 120, the potatoes are diced 122. Next, the potatoes are heated 124, for example by cooking the potatoes. After heating 124, the potatoes are cooled 126. Next, excess water may be removed from the potatoes in a dewatering process 128 and the potatoes may be dried 130 before being reduced in particle size 132. Optionally, the potatoes may be mixed with other ingredients 134, such as flavoring ingredients. Next, the potatoes are sterilized 136. Then the potatoes may be cooled 138 before being aseptically packaged 140. Lastly, the packaged product is stored 142.

To prepare the potatoes for the process 114 of FIG. 2, the potatoes may be washed 118, peeled, sorted 120, and/or diced 122. The potatoes may be washed using an acid wash or any wash or wash sequence 118 known in the art, now or in the future. After the wash 118, the potatoes may be immediately sorted or preferably peeled. As will be understood by one of skill in the art, certain products may preferably include peels. If desired, some methods of peeling include steaming the potatoes or using caustic. Any method of peeling known in the art, now or in the future, may be used. The potatoes may then be sorted 120 to eliminate potatoes which include defects or abnormalities. Any method of sorting may be used, whether known now or in the future. The potatoes may then be reduced to a pre-processing size to promote uniform heating or cooking in later steps. The potatoes may be reduced in size by dicing 122 or by any method known in the art now or in the future. Finally, the potatoes may be prepared for the process of FIG. 2 by being examined and sorted to remove internal defects or abnormalities using any method of sorting known now or in the future.

After the optional preparation steps, the potatoes are heated 124. In the preferred embodiment, the potatoes are cooked all the way through so that they may be mashed later in the process. Fruits and vegetables, such as potatoes, include starch grains that consist of molecules of starch and pectins chemically linked together with covalent bonds. When the starch grains are heated, they swell and separate. Swelling of the starch grains is called gelatinization, which allows the potatoes to be mashed to the proper consistency. Specifically, the product may be heated using a process that may employ boiling water or retrogradation. When this process is used to heat fruits and/or potatoes, separation of the starch grains is reduced and a firm gel is formed. Therefore, the cooked product may be prevented from crumbling, disintegrating, or developing an undesirable taste and/or texture.

The potatoes may be heated 124 using a heating device such as a water bath that utilizes steam or boiling water, as discussed above. To cook the potatoes all the way through, the potatoes may be heated to a temperature between 120 degrees Fahrenheit and 212 degrees Fahrenheit, such as to 150 to 212 degrees Fahrenheit, or most preferably 130 to 170 degrees Fahrenheit. For example, the potatoes may be cooked to 120 degrees Fahrenheit, 125 degrees Fahrenheit, 130 degrees Fahrenheit, 135 degrees Fahrenheit, 140 degrees Fahrenheit, 145 degrees Fahrenheit, 150 degrees Fahrenheit, 155 degrees Fahrenheit, 160 degrees Fahrenheit, 165 degrees Fahrenheit, 170 degrees Fahrenheit, 175 degrees Fahrenheit, 180 degrees Fahrenheit, 185 degrees Fahrenheit, 190 degrees Fahrenheit, 195 degrees Fahrenheit, 200 degrees, 205 degrees Fahrenheit, 210 degrees Fahrenheit, and/or 212 degrees Fahrenheit. Preferably, the potatoes are heated to a temperature of about 160 degrees Fahrenheit. Accordingly, the potatoes are heated to a temperature wherein the starch is gelatinized.

Referring again to FIG. 2, the potatoes are cooled 126. As discussed above, fruits and vegetables, such as potatoes, may be heated or cooked using a process called retrogradation. As the heated or cooked starch grains cool, the molecules of starch and pectin may begin to realign. The realignment of the molecules during the cooling step 126 aids in gelatinizing the starch in the potatoes. Additionally, this step may allow free starch in the product to be washed away and therefore reduce free starch in the final product. While this step may be optional in some embodiments, cooling sets the gelatinized starch cell structure such that the cells are firmer and do not break. Breakage of the cells leads to free starch in the mashed potatoes, which leads to an undesirable taste and/or texture, such as a gluey taste and/or texture. Accordingly, it is preferred to keep the starch cells intact and reduce free starch in the final product.

The potatoes may be cooled to between 55 degrees Fahrenheit and 100 degrees Fahrenheit. The potatoes may be cooled to 55 degrees Fahrenheit, 60 degrees Fahrenheit, 65 degrees Fahrenheit, 70 degrees Fahrenheit, 75 degrees Fahrenheit, 80 degrees Fahrenheit, 85 degrees Fahrenheit, 90 degrees Fahrenheit, 95 degrees Fahrenheit. In preferred embodiments, the potatoes may be cooled to room/ambient temperature or below. The potatoes may be cooled using liquid nitrogen, cold air, gaseous carbon dioxide, or other cooling devices known now or in the future. Preferably, a cooling water bath or shower may be used to cool the potatoes and to remove excess free starch from the product. In some embodiments, the potatoes may be blanched, which involves both heating and cooling of the potatoes.

After cooling 126, the potatoes may be dewatered 128. In the preferred embodiment, water that may have been used to cool 126 the potatoes is removed. The potatoes may be dewatered 128 using any method known now or in the future including draining the water around the potatoes. Subsequently, the potatoes may be dried 130 to remove any remaining excess water from the potatoes. The potatoes may be dried 130 using any method known now or in the future including using a perforated or mesh belt, a screen to allow water to drip away, or preferably an air knife. Removing excess water from the potatoes by dewatering 128 and/or drying 130 ensures free starch contained in the water around the potatoes is removed. It is important to remove this free starch to avoid an undesirable gluey taste and/or texture in the final mashed potato product.

After the potatoes have been cooled 126, dewatered 128, and dried 130, the particle size of the pre-processing size potato pieces may be further reduced 132. In preferred embodiments, the potatoes are reduced to ¼ inch or less. In some embodiments, the potatoes may go through a die, press, ricer, or other mechanical shredding device. As discussed above, it is important in this step to maintain the integrity of the starch cell structure, for example the starch cell wall, and to avoid breaking the cell structure, such as the cell wall. Breakage will result in undesirable free starch in the product. One way to ensure that the cell structure does not break is to use a die, press, or ricer around ¼ inch. To aid in this step, in some embodiments a lubricant such as butter or another similar material may be added prior to or during the reduction in size 132. Moreover, this sequence may include a sieve, die, and/or press where the holes are round with radiated corners. Accordingly, there are no sharp edges or corners to break the cell structure. Preferably, the resulting reduced-size pieces will accumulate in a holding tank for further reprocessing.

At this point, further ingredients may be added to the potatoes 134. For example, salt, pepper, cream, garlic, cheese, butter, vitamins, and/or other flavorings may be added to the potatoes. This step may occur in the holding tank discussed above. The potatoes, with or without other ingredients, may be mixed in the holding tank.

After further ingredients have been added, the potatoes are sterilized 136. Sterilization may occur by any method known in the art, now or in the future. The sterilizer may utilize heat, high pressure, irradiation, microwave, chemical treatment, direct or indirect thermal resistance, radio frequency, ohmic, or any other system which will adequately sterilize the potato product. In some embodiments, the potatoes may be sterilized by heating the potatoes to a particular temperature and holding the potatoes at or above that temperature for a period of time which is sufficient to kill pathogens and halt enzymatic reactions in the product. It should be appreciated that the desired temperature may vary according to the desired results. The heating may occur via ohmic processes or a surface heat exchanger, although other methods and/or equipment may be used. For example, a scrape surface heat exchanger, commercially available from APV Crepaco, Inc., may be used. The scrape surface heat exchanger includes a cylindrical space containing a continuously rotating blade/auger which scrapes along the walls of the space to remove product from the walls. The walls of the exchanger are externally heated.

In the present invention, the potatoes may be heated to between about 250 degrees Fahrenheit and 312 degrees Fahrenheit, such as from 250 degrees Fahrenheit to 275 degrees Fahrenheit. The sterilization temperature may be 250 degrees Fahrenheit, 255 degrees Fahrenheit, 260 degrees Fahrenheit, 265 degrees Fahrenheit, 270 degrees Fahrenheit, 275 degrees Fahrenheit, 280 degrees Fahrenheit, 285 degrees Fahrenheit, 290 degrees Fahrenheit 295 degrees Fahrenheit, 300 degrees Fahrenheit, 305 degrees Fahrenheit, 310 degrees Fahrenheit, and/or 312 degrees Fahrenheit. In some embodiments, the sterilization temperature may be 250 degrees Fahrenheit when the potato particle size is ¼ inch or smaller. However, in some embodiments, the particle size could be larger, such as when a final product having larger chunks of potato is desired. In such case, different sterilization methods and/or parameters may be used. While the time and temperature of the sterilization may change, in some embodiments it may be important to achieve a 5 log kill step and/or to allow the sterilization's heat to halt enzymatic reactions so as to prolong the shelf life of the resulting product. One advantage of sterilizing the product prior to packaging is that it allows for shorter sterilization time, resulting in a superior product.

After sterilization 136, the potatoes may be cooled 138. The product may be cooled in a cooling device where the heating process is stopped. One cooling device which may be used is a scrape surface heat exchanger, commercially available from APV Crepaco, Inc. The scrape surface heat exchanger is similar to the device described above except that the walls of the device are externally cooled.

After the product has cooled 138, the product is aseptically packaged 140 using methods known in the art, now or in the future. The preferred method of packaging 140 includes an aseptic packager. The aseptic packager operates by using steam or hydrogen peroxide in combination with steam to clean and sterilize a spout at a temperature sufficient to kill pathogens. Next, the aseptic packager injects the sterilized mashed potato product into bags through the sterilized spout. The mashed potato product could be prepared for any ultimate use, including but not limited to commercial, industrial, individual and/or retail use, in any type of container known now or in the future such as large bulk bags, single serving bags, or cups for single family use. The containers may be comprised of packaging material that may include high barrier material or foil barrier bags that could form a barrier against oxygen, light, pathogens, moisture, and/or temperature changes. The containers and/or packaging material may be made aseptic through irradiation or any other known sterilization method.

Finally, the aseptically packaged 140 product of the present invention can be shipped to a final destination for purchase or use. In some embodiments, the product may have a shelf-life of one year or more without degrading. The packages of mashed potatoes may be stored 142 at a range of temperatures, such as 32 degrees Fahrenheit to 120 degrees Fahrenheit, or more preferably 40-100 degrees Fahrenheit without changes in food quality. The storage temperature may be 32 degrees Fahrenheit, 35 degrees Fahrenheit, 40 degrees Fahrenheit, 45 degrees Fahrenheit, 50 degrees Fahrenheit, 55 degrees Fahrenheit, 60 degrees Fahrenheit, 65 degrees Fahrenheit, 70 degrees Fahrenheit, 75 degrees Fahrenheit, 80 degrees Fahrenheit, 85 degrees Fahrenheit, 90 degrees Fahrenheit, 95 degrees Fahrenheit, 100 degrees Fahrenheit, 105 degrees Fahrenheit, 110 degrees Fahrenheit, 115 degrees Fahrenheit, and/or 120 degrees Fahrenheit. In some embodiments, the packages of mashed potatoes may be stored 142 at room temperature, however, storage temperatures of about 60 degrees Fahrenheit to 70 degrees Fahrenheit are preferred. With the methods of the present invention, the product requires no preservatives to maintain the described shelf life.

After the product is shipped, the packaged aseptic potatoes can be warmed in a static warmer hours before use. This will allow convenient use of the mashed potatoes at the correct temperature without added labor or waste of premade mashed potatoes.

The above steps may take place as a continuous process. In such a case, a pump may be used to move the potatoes through the various steps. In one example, the pump may be used to move the potatoes from the holding tank wherein the potatoes are mixed with flavoring through the sterilization process. Pumps which are useful in the present invention include, but are not limited to, positive displacement pumps such as lobe pumps and piston pumps. As a pump presents another opportunity for the cell structure to be damaged, proper methods should be used to ensure the integrity of the cells. As discussed above, if the cells are damaged, free starch can be released which results in a low-quality product. Moreover, the initial cooling step 126 described above will set the cell structure to avoid breakage.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A process for aseptically preparing fruits and vegetables having starch, comprising:
heating said fruits and vegetables to a first temperature sufficient to firmly gelatinize said starch in said fruits and vegetables; and
cooling said fruits and vegetables following said heating to a second temperature sufficient to set the starch cell structure.

2. The process of claim 1 wherein said first temperature is between 120 degrees Fahrenheit and 212 degrees Fahrenheit.

3. The process of claim 2 wherein said first temperature is between 150 and 212 degrees Fahrenheit.

4. The process of claim 3 wherein said first temperature is between 130 and 170 degrees Fahrenheit.

5. The process of claim 1 wherein said second temperature is between 55 and 100 degrees Fahrenheit.

6. The process of claim 1 wherein said cooling reduces free starch in said aseptically prepared fruits and vegetables.

7. The process of claim 1 further comprising sterilizing said fruits and vegetables following said cooling step.

8. The process of claim 7 wherein said fruits and vegetables are reduced in size following said cooling step and prior to said sterilizing step.

9. The process of claim 8 wherein said sterilization step includes a 5 log kill step.

10. The process of claim 9 wherein said sterilization halts enzymatic reactions.

11. The process of claim 1 wherein said fruit and vegetable is a potato.

12. A process for aseptically preparing mashed potatoes from at least one potato having starch, comprising:
heating said potatoes to a first temperature between 120 degrees Fahrenheit and 212 degrees Fahrenheit;
cooling said potatoes to a second temperature between 55 and 100 degrees Fahrenheit; and
sterilizing said potatoes.

13. The process of claim 12 wherein said potatoes are processed into particles having a first size prior to said heating.

14. The process of claim 13 wherein the particles having a first size are reduced in size to particles having a second size after said cooling step and prior to said sterilization step.

15. The process of claim 14 wherein said second size is one quarter inch.

16. The process of claim 12 wherein said heating step firmly gelatinizes said starch.

17. The process of claim 12 wherein said potatoes have at least one starch cell wall and said cooling step sets the structure of said starch cell wall such that it is less likely to break prior to consumption than if said cooling step had not occurred.

18. The process of claim 12 wherein said sterilization step includes a 5 log kill step.

19. The process of claim 18 wherein said sterilization halts enzymatic reactions.

20. A process for aseptically preparing mashed potatoes from at least one potato having starch and at least one starch cell wall, comprising:
dicing said potato;
heating said diced potato to a first temperature of about 120 to 212 degrees Fahrenheit such that said heating firmly gelatinizes said starch;
cooling said potato, wherein said cooling increases the rigidity of said at least one starch cell wall;
reducing the particle size of said cooled potato to about ¼ inch; and
sterilizing said potatoes wherein said sterilization includes a 5 log kill step and heat from said sterilization halts enzymatic reactions in said potatoes.
